(19) United States
(12) Patent Application Publication
(10) Pub. No.: US 2010/0139601 A1
(43) Pub. Date: Jun. 10, 2010

(54) CONTROL SYSTEM FOR INTERNAL COMBUSTION ENGINE

(75) Inventors: Hideharu Takamiya, Wako-shi (JP); Hirohito Ide, Wako-shi (JP); Seiichiro Irie, Wako-shi (JP); Hideyuki Jinzai, Wako-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/633,574

(22) Filed: Dec. 8, 2009

(30) Foreign Application Priority Data
Dec. 10, 2008 (JP) 2008-313832

(51) Int. Cl. F02D 41/06; F01L 1/34

(52) U.S. Cl. 123/179.16; 123/90.15

(57) ABSTRACT

A control system for an internal combustion engine having a valve operating characteristic varying device which continuously changes a lift amount of at least one intake valve. Operation of a start switch, which instructs the start of the engine is detected. The engine is started after a predetermined delay time period has elapsed from the moment the operation of the start switch is detected. The valve operating characteristic varying device is operated during the predetermined delay time period, and a failure determination of the valve operating characteristic varying device is performed.

### BACKGROUND OF THE INVENTION

1. Field of the Invention

The present invention relates to a control system for an internal combustion engine, and particularly to a control system for an internal combustion engine having a valve operating characteristic varying mechanism for continuously varying a lift amount of the intake valve(s).

2. Description of the Related Art

Japanese Patent Laid-open No. 2003-172189 (JP '189) discloses a control system for an internal combustion engine having a valve operating characteristic varying mechanism which continuously changes a lift amount of intake valves. According to the control system disclosed by JP '189, the engine is automatically stopped when a predetermined stop condition is satisfied, and the engine is automatically started when a predetermined automatic start condition is satisfied after the automatic stoppage. During a predetermined time period after the automatic start, the lift amount of an intake valve is fixed at a predetermined lift amount, and the intake air flow rate is controlled by the throttle valve.

Since the valve operating characteristic varying mechanism is an essential element for controlling the intake air flow rate of the engine, quick failure detection or determination is expected when the mechanism fails. It is preferable that the failure determination does not affect the normal operation of the engine, and is performed at a comparatively high frequency. For example, in the conventional control system disclosed by JP '189, the time period between the automatic stop and the automatic start is suitable for the failure determination to take place since the failure determination barely affects normal engine operation. However, there is a possibility that the failure determination cannot be completed, since the time period between engine stop and engine start is not fixed.

### SUMMARY OF THE INVENTION

The present invention was derived in contemplation of the above-described points, and an aspect of the present invention is to provide a control system for an internal combustion engine which performs a failure determination of the valve operating characteristic varying mechanism at a comparatively high frequency without affecting normal engine operation.

The present invention provides a control system for an internal combustion engine having a valve operating characteristic varying mechanism which continuously changes a lift amount of at least one intake valve. The control system includes a start switch which instructs the start of the engine, an engine starter, and a failure determination device. The engine starter starts the engine after a predetermined delay time period (TSDLY) has elapsed from the moment the start switch is operated. The failure determination device operates the valve operating characteristic varying mechanism during the predetermined delay time period (TSDLY), and performs a failure determination of the valve operating characteristic varying mechanism.

With the above-described structural configuration, when the start switch is operated, the engine starts after the predetermined delay time period has elapsed from the moment the start switch is operated. During the predetermined delay time period, the valve operating characteristic varying mechanism is operated and the failure determination is performed. The predetermined delay time period from operation of the start switch to the actual beginning of the engine being started can be set to a fixed time period within the limit wherein the driver does not sense a disturbance. Accordingly, the time period required for the failure determination operation to occur is maintained at a relatively high degree of certainty. Further, since the failure determination always is performed immediately before the beginning of the engine being started, the failure determination is performed at a comparatively high frequency without affecting normal operation of the engine.

Preferably, the control system further includes an inhibiting mechanism which inhibits the failure determination operation of the failure determination mechanism after a predetermined time period (TESTH) has elapsed from the end of a preceding engine operation.

With the above-described structural configuration, the failure determination is inhibited after the predetermined time period has elapsed from the end of the preceding engine operation. The valve operating characteristic varying mechanism can smoothly operate with lubricating oil supplied during engine operation. However, if the engine stoppage time period is unduly extended or becomes too long and exceeds the predetermined time period (for example, one week), any lubricating oil film that has adhered to movable parts during engine operation is lost. Accordingly, if the valve operating characteristic varying mechanism is operated in such a state before the engine is started, problems, such as accelerated abrasion of movable parts or excessive load on the motor, will occur. Therefore, by inhibiting the failure determination when the engine stoppage period has exceeded the predetermined time period, the problems caused by a lack of lubricant film are avoided.

Preferably, the valve operating characteristic varying mechanism has a motor which varies the lift amount and a drive circuit which drives the motor, and the failure determination device performs a failure determination of the motor during the predetermined delay time period (TSDLY).

With the above-described structural configuration, the failure determination of the motor is performed during the predetermined delay time period. Accordingly, a failure of the motor can be detected distinct from other failures.

Preferably, the failure determination device performs a failure determination of the drive circuit during the predetermined delay time period (TSDLY).

With the above-described structural configuration, the failure determination of the motor drive circuit is performed during the predetermined delay time period. Accordingly, a failure of the motor drive circuit is detected distinct from other failures.

Preferably, the control system further includes an intake pressure sensor for detecting an intake pressure of the engine, an atmospheric pressure sensor for detecting an atmospheric pressure, and a correction amount calculator. The correction amount calculator calculates a correction amount (DPA) for correcting a detected value (PA) of the atmospheric pressure sensor according to a detected value (PBA) of the intake pressure sensor during the predetermined delay time period (TSDLY).

With the above-described structural configuration, the correction amount for correcting the detected value of the atmospheric pressure sensor is calculated according to the detected value of the intake pressure sensor during the predetermined delay time period. It is known that calculation of the correction amount is performed during engine stoppage. However, there is a possibility that the accuracy of the calculated correction amount may be reduced due to changes in environmental conditions if the time period from calculation of the correction amount to the actual start of the engine is unduly extended or too long. Therefore, by calculating the correction amount during the predetermined delay time period, the correction amount is calculated with a relatively high degree of accuracy.

Preferably, the control system further includes an abnormality determinator which determines that at least one of the intake pressure sensor and the atmospheric pressure sensor is abnormal when the correction amount (DPA) calculated by the correction amount calculator is greater than a predetermined threshold value (DPATH).

With the above-described structural configuration, it is determined that at least one of the intake pressure sensor and the atmospheric pressure sensor is abnormal if the correction amount of the detected atmospheric pressure sensor value is greater than the predetermined threshold value. Therefore, abnormality of the intake pressure sensor and/or the atmospheric pressure sensor can be detected quickly.

### BRIEF DESCRIPTION OF THE DRAWINGS

FIG. 1 is a schematic diagram of an internal combustion engine and a control system therefor according to an embodiment of the present invention;

FIG. 2 is a schematic diagram of a valve operating characteristic varying device shown in FIG. 1;

FIGS. 3A and 3B illustrate a simplified configuration of a valve operating characteristic varying mechanism shown in FIG. 2;

FIGS. 4A and 4B are graphs showing valve operating characteristics of an intake valve;

FIG. 5 is a block diagram of a control system of the valve operating characteristic varying mechanism;

FIG. 6 is a flowchart of the process executed by the execution condition determination block of FIG. 5;

FIG. 7 is a time chart illustrating a failure determination method;

FIG. 8 is a flowchart of the process executed by the failure determination block of FIG. 5;

FIG. 9 is a flowchart of the process for calculating a correction amount used for correcting a detected value of the atmospheric pressure sensor;

FIG. 10 is a circuit diagram showing a configuration of a drive system of the first valve operating characteristic varying mechanism (using a brushless DC motor);

FIGS. 11A and 11B are time charts showing drive signals for the failure determination and detection signals;

FIG. 12 is a circuit diagram of a drive system of the valve operating characteristic varying mechanism using a brush DC motor;

FIGS. 13A and 13B are time charts showing drive signals for the failure determination and detection signals;

FIGS. 14A and 14B are time charts showing drive signals for the failure determination and detection signals; and

FIG. 15 is a flowchart showing the process for performing a failure determination of the drive system of the valve operating characteristic varying mechanism.

### DETAILED DESCRIPTION OF THE PREFERRED EMBODIMENTS

Preferred embodiments of the present invention will now be described with reference to the drawings.

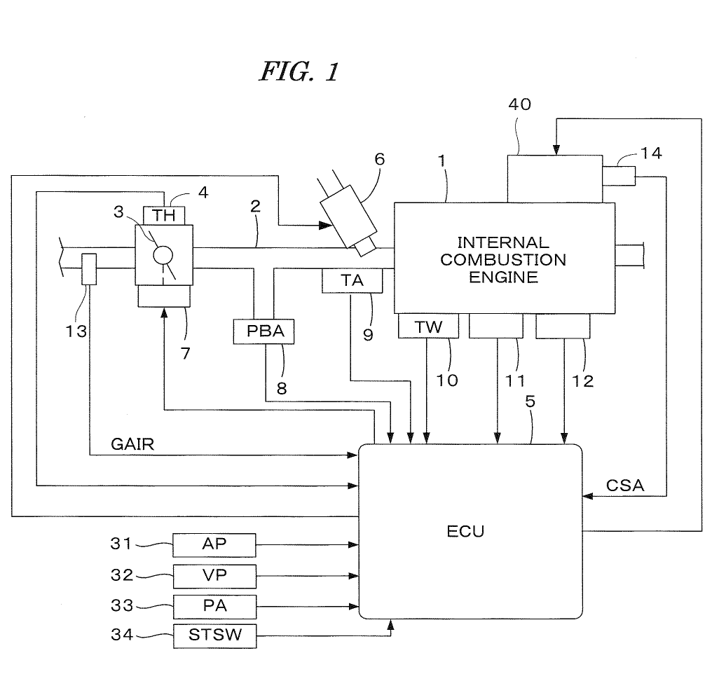

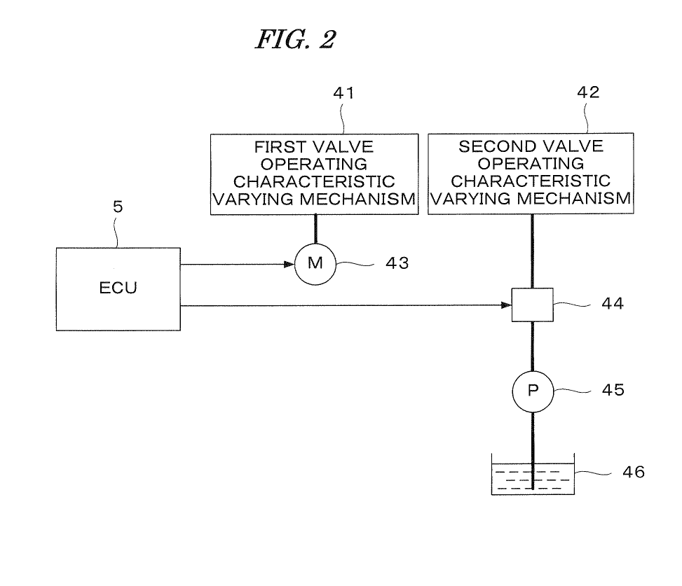

FIG. 1 is a schematic diagram of an internal combustion engine and a control system therefor according to an embodiment of the present invention, and FIG. 2 is a schematic diagram showing a configuration of a valve operating characteristic varying device. Referring to FIG. 1, an internal combustion engine 1 (hereinafter referred to as “engine”), having, for example, four cylinders is provided with intake valves, exhaust valves, and cams for driving the intake and exhaust valves. The engine 1 is provided with a valve operating characteristic varying device 40 having a first valve operating characteristic varying mechanism 41 and a second valve operating characteristic varying mechanism 42. The first valve operating characteristic varying mechanism 41 continuously varies the valve lift amount and the opening angle (valve opening period) of the intake valve. The second valve operating characteristic varying mechanism 42 is a cam phase varying mechanism for continuously varying the operating phases of the cams for driving the intake valves with reference to a rotational angle of the crank shaft of the engine 1. The second valve operating characteristic varying mechanism 42 varies the operating phase of the cam for driving each intake valve, and consequently varies the operating phase of each intake valve.

The engine 1 has an intake pipe 2 provided with a throttle valve 3. A throttle valve opening (TH) sensor 4 is connected to the throttle valve 3, outputs an electrical signal corresponding to an opening of the throttle valve 3, and supplies the electrical signal to an electronic control unit (referred to as “ECU”) 5. An actuator 7 for actuating the throttle valve 3 is connected to the throttle valve 3, wherein operation of the actuator 7 is controlled by the ECU 5.

Fuel injection valves 6 are positioned within the intake pipe 2 at locations between the cylinder block of the engine 1 and the throttle valve 3 slightly upstream of the respective intake valves (not shown). The fuel injection valves 6 are connected to a fuel pump (not shown), and electrically connected to the ECU 5. A valve opening period of each fuel injection valve 6 is controlled by a signal output from the ECU 5.

An intake pressure sensor 8 for detecting an intake pressure PBA and an intake air temperature sensor 9 for detecting an intake air temperature TA are disposed downstream of the throttle valve 3. Further, an engine coolant temperature sensor 10 for detecting an engine coolant temperature TW is mounted on the body of the engine 1. An intake air flow rate sensor 13 for detecting an intake air flow rate GAIR of the engine 1 is disposed upstream of the throttle valve 3. The detection signals from the sensors 8, 9, 10, and 13 are supplied to the ECU 5.

A crank angle position sensor 11 and a cam angle position sensor 12 are connected to the ECU 5. The crank angle position sensor 11 detects a rotational angle of the crankshaft (not shown) of the engine 1, and the cam angle position sensor 12 detects a rotational angle of a camshaft to which the cams for driving the intake valves of the engine 1 are fixed. A signal corresponding to the rotational angle detected by the crank angle position sensor 11 and a signal corresponding to the rotational angle detected by the cam angle position sensor 12 are supplied to the ECU 5. The crank angle position sensor 11 generates one pulse (hereinafter referred to as “CRK pulse”) at every constant crank angle period (e.g., a period of 30 degrees) and a pulse for specifying a predetermined angle position of the crankshaft. The cam angle position sensor 12 generates a pulse at a predetermined crank angle position for a specific cylinder of the engine 1 (this pulse will be hereinafter referred to as “CYL pulse”). The cam angle position sensor 12 further generates a pulse at a top dead center (TDC) starting the intake stroke in each cylinder (this pulse will be hereinafter referred to as “TDC pulse”). These pulses are used to control various timings, such as a fuel injection timing and an ignition timing, as well as to detect an engine rotational speed NE. An actual operating phase CAIN of the camshaft is detected based on the correlation between the TDC pulse output from the cam angle position sensor 12 and the CRK pulse output from the crank angle position sensor 11.

An accelerator sensor 31, a vehicle speed sensor 32, and an atmospheric pressure sensor 33 are also connected to the ECU 5. The accelerator sensor 31 detects a depression amount AP of an accelerator pedal of the vehicle driven by the engine 1 (this depression amount will be hereinafter referred to as “accelerator operation amount”). The vehicle speed sensor 32 detects a running speed (vehicle speed) VP of the vehicle. The atmospheric pressure sensor 33 detects an atmospheric pressure PA. The detection signals from the sensors 31, 32 and 33 are supplied to the ECU 5. Further, a start switch 34 which starts the engine 1 is connected to the ECU 5, and a switching signal of the start switch 34 is supplied to the ECU 5.

The valve operating characteristic varying device 40, as shown in FIG. 2, includes a first valve operating characteristic varying mechanism 41, a second valve operating characteristic varying mechanism 42, a motor 43, and a solenoid valve 44. The first valve operating characteristic varying mechanism 41 continuously varies a lift amount and an opening angle (hereinafter referred to simply as “lift amount LFT”) of each intake valve. The second valve operating characteristic varying mechanism 42 continuously varies an operating phase of each intake valve. The motor 43 continuously changes the lift amount LFT of each intake valve. An opening of the solenoid valve 44 is continuously varied to change the operating phase of each intake valve. The operating phase CAIN of the camshaft is used as a parameter indicative of the operating phase of the intake valve. A lubricating oil contained in an oil pan 46 is pressurized by an oil pump 45 and supplied to the solenoid valve 44. It is to be noted that a specific configuration of the second valve operating characteristic varying mechanism 42 is described, for example, in Japanese Patent Laid-open No. 2000-227013.

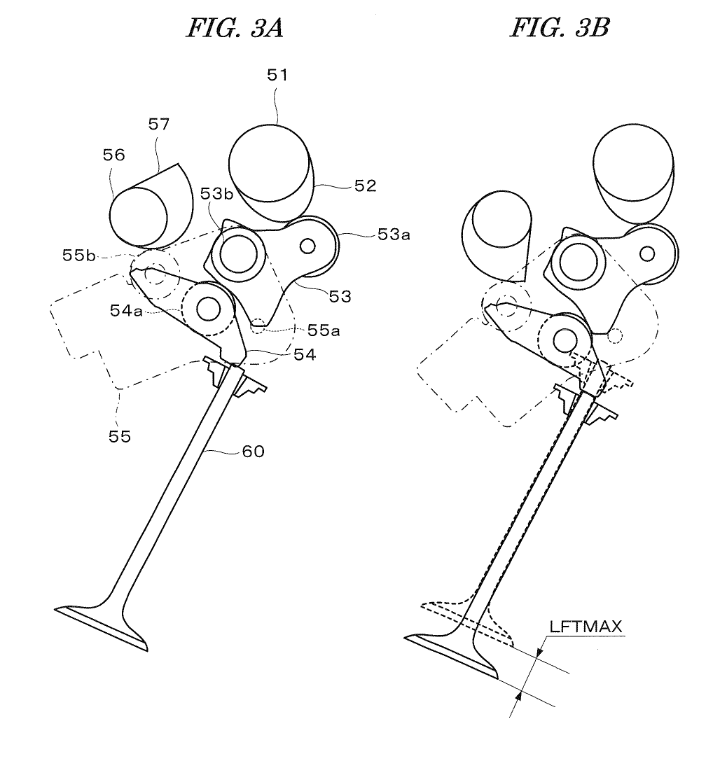

As shown in FIG. 3A, the first valve operating characteristic varying mechanism 41 includes a camshaft 51, a control arm 55, a control shaft 56, a sub-cam 53, and a rocker arm 54. The camshaft 51 is provided with a cam 52. The control arm 55 is supported by the cylinder head enabling the control arm 55 to pivot around a shaft 55a. The control shaft 56 is provided with a control cam 57, which pivots the control arm 55. The sub-cam 53 is supported by the control arm 55 through a supporting shaft 53b which enables the sub-cam 53 to pivot around the supporting shaft 53b. The sub-cam 53 is actuated by the cam 52. The rocker arm 54 is actuated by the sub-cam 53 and drives (opens and closes) an intake valve 60. The rocker arm 54 is supported in the control arm 55 which enables the rocker arm 54 to pivot.

The sub-cam 53 has a roller 53a abutting the cam 52, and pivots around the shaft 53b by rotation of the camshaft 51. The rocker arm 54 has a roller 54a abutting the sub-cam 53. The movement of the sub-cam 53 is transmitted to the rocker arm 54 through the roller 54a.

The control arm 55 has a roller 55b abutting the control cam 57 and pivots around the shaft 55a by rotation of the control shaft 56. In the state shown in FIG. 3A, the intake valve 60 maintains a substantially fully-closed state, since movement of the sub-cam 53 is not substantially transmitted to the rocker arm 54. On the other hand, in the state shown in FIG. 3B, the movement of the sub-cam 53 is transmitted to the intake valve 60 through the rocker arm 54, and the intake valve 60 opens to a maximum lift amount LFTMAX (e.g., 12 mm).

Therefore, the lift amount LFT of the intake valve 60 is continuously varied by pivoting the control shaft 56 with the motor 43. In this embodiment, the first valve operating characteristic varying mechanism 41 includes a control shaft rotational angle sensor 14 which detects a rotational angle (hereinafter referred to as “CS angle”) CSA of the control shaft 56. The detected CS angle CSA is used as a parameter indicative of the lift amount LFT.

It is to be noted that the detailed configuration of the first valve operating characteristic varying mechanism 41 is described in Japanese Patent Laid-open No. 2008-25418 by Honda Motor Co. Ltd, the contents of which are hereby incorporated by reference.

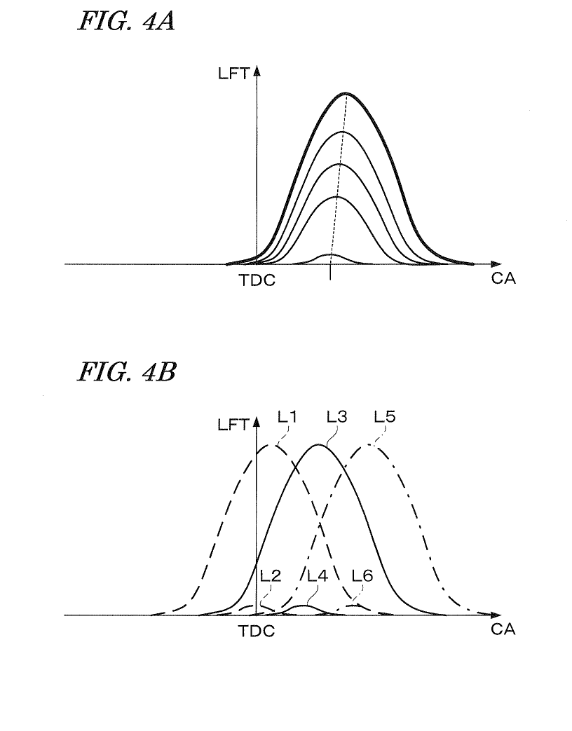

According to the first valve operating characteristic varying mechanism 41, the lift amount LFT (and the opening angle) of the intake valve is varied, as shown in FIG. 4A. Further, according to the second valve operating characteristic varying mechanism 42, the intake valve is driven with a phase from the most advanced phase, shown by the broken lines L1 and L2 in FIG. 4B to the most retarded phase, shown by the dot-and-dash lines L5 and L6 in FIG. 4B, depending on a change in the operating phase CAIN of the camshaft. In FIG. 4B, the characteristics shown by the solid lines L3 and L4 are the center of the variable phase range.

The ECU 5 includes an input circuit having various functions including shaping the waveforms of input signals from the various sensors, correcting the voltage levels of the input signals to a predetermined level, and converting analog signal values into digital signal values. The ECU 5 further includes a central processing unit (hereinafter referred to as “CPU”), a memory circuit, and an output circuit. The memory circuit preliminarily stores various operating programs to be executed by the CPU and the computation results or the like by the CPU. The output circuit supplies drive signals to the actuator 7, the fuel injection valves 6, the motor 43, and the solenoid valve 44.

The CPU in the ECU 5 controls an opening of the throttle valve 3, an amount of fuel to be supplied to the engine 1 (the opening period of each fuel injection valve 6), and the valve operating characteristic (intake air flow rate) through the motor 43 and the solenoid valve 44, according to the detected signals from the above-described sensors.

During lift amount control (CS angle control) of the intake valve, a lift amount command value LFTCMD of the intake valve is calculated according to an engine operating condition, and a CS angle command value CSACMD is calculated according to the lift amount command value LFTCMD. Further, a feedback control of a drive current IMD of the motor 43 is performed wherein the detected CS angle CSA coincides with the CS angle command value CSACMD.

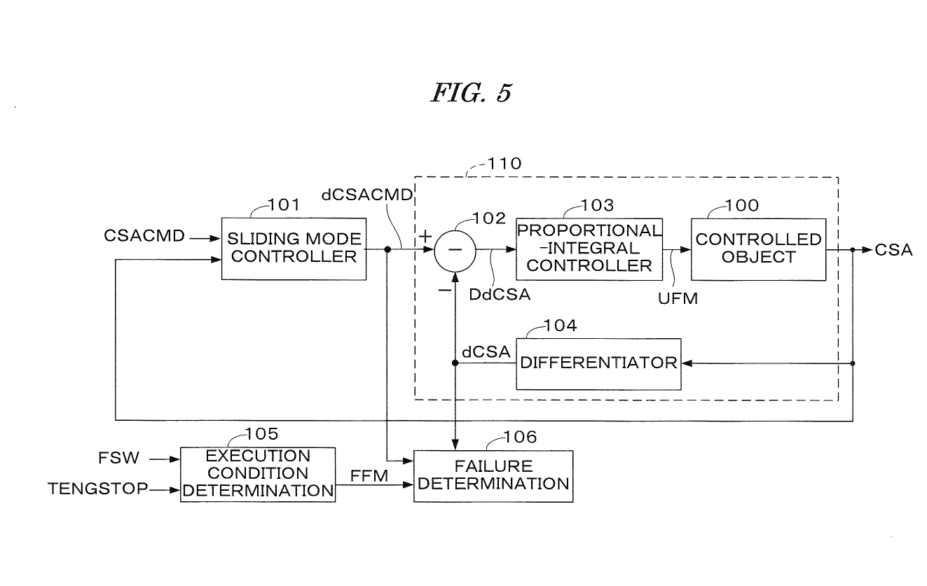

FIG. 5 is a block diagram showing a configuration of a control system. The control system shown in FIG. 5 includes a sliding mode controller 101, a subtractor 102, a proportional-integral controller 103, a differentiator 104, a controlled object 100, an execution condition determination block 105, and a failure determination block 106. The controlled object 100 includes a motor drive circuit (not shown) and a motor 43, and the first valve operating characteristic varying mechanism 41. The motor drive circuit converts a control input signal which is output from the proportional-integral controller 103 to a motor drive current IMD. Further, the sliding mode controller 101, the subtractor 102, the proportional-integral controller 103, the differentiator 104, the execution condition determination block 105, and the failure determination block 106 are determined by an operational process executed by the CPU in the ECU 5.

The sliding mode controller 101 calculates a target CS angular speed dCSACMD with the sliding mode control so that the actual CS angle CSA coincides with the CS angle command value CSACMD.

The differentiator 104 calculates the CS angular speed dCSA by differentiating the CS angle CSA. The subtractor 102 calculates an angular speed deviation DdCSA by subtracting the CS angular speed dCSA from the target CS angular speed dCSACMD.

The proportional-integral controller 103 calculates a control input UFM with the proportional-integral control so that the angular speed deviation DdCSA becomes “0”. The motor drive current IMD is set to be proportional to the control input UFM.

The execution condition determination block 105 determines the execution condition of the failure determination of the controlled object 100, and outputs a failure determination flag FFM which is set to “1” when permitting the execution of the failure determination. The failure determination block 106 performs the failure determination of the controlled object 100 when the failure determination flag FFM is set to “1”.

Next, the function of each block shown in FIG. 5 will be described in detail. An object transfer function G(s), which is a transfer function of the controlled object 100 (more properly, a transfer function of a controlled object model obtained by modeling the controlled object 100), is expressed with equation (1). In equation (1), “s” is the Laplace operator. Further, “J” and “B” in equation (1) are constants determined by the characteristics of the motor 43 and the first valve operating characteristic varying mechanism 41, for example, a motor torque constant, a gear reduction ratio, an inertia moment of the motor 43, an inertia moment of the control shaft 56, and the like.

$$G ( s ) = \frac{1}{J \cdot {s}^{2} + B \cdot s} \qquad ( 1 )$$

Further, a transfer function H(s) of the proportional-integral controller is expressed by equation (2). In equation (2), “τ” is a time constant that is set to a desired value.

$$H ( s ) = \frac{J \cdot s + B}{τ \cdot s} \qquad ( 2 )$$

When the transfer function H(s) is expressed by equation (2), a proportional control gain KP and an integral control gain KI are, respectively, determined by equations (3) and (4).

KP=J/τ (3)

KI=B/τ (4)

Taking into consideration that the transfer function of the differentiator 104 is “s”, a transfer function F(s) of a controlled object 110 in FIG. 5 of the sliding mode controller (this controlled object will be referred to as “extended controlled object”) is determined by equation (5).

$$F ( s ) = \frac{1}{τ \cdot s + 1} \cdot \frac{1}{s} \qquad ( 5 )$$

Next, a calculation method of the target CS angular speed dCSACMD in the sliding mode controller 101 will be described. If the target CS angular speed dCSACMD is expressed with a control input USL, the control input USL is calculated as a sum of an equivalent control input UEQ and a reaching law control input URCH, as shown in equation (11). In equation (11), “k” is a discrete time digitized with the control period T.

USL(k)=UEQ(k)+URCH(k) (11)

Further, by converting the transfer function F(s) of the extended controlled object 110 determined by equation (5) to a corresponding transfer function of the discrete time system, and expressing the CS angle CSA(k), which is the controlled output, using past values of the CS angle CSA and the feedback control input USL (CS angular speed dCSACMD), which is the control input, equation (12), which defines the controlled object model, is obtained.

CSA(k)=a11×CSA(k−1)+a12×CSA(k−2)+b11×USL(k−1)+b12×USL(k−2) (12)

In equation (12), the model parameters a11, a12, b11, and b12 are model parameters of the discrete time system model, and are calculated with the well-known method using the model parameter τ of the continuous time system model and the control period T.

The switching function value σ(k) is defined by equation (14) using a control deviation DCSA calculated by equation (13).

DCSA(k)=CSACMD(k)−CSA(k) (13)

σ(k)=DCSA(k)+VPOLE×DCSA(k−1) (14)

In equation (14), “VPOLE” is a switching function setting parameter which determines the damping characteristic of the control deviation DCSA and is set to a value greater than “−1” and less than “0”.

The equivalent control input UEQ is a control input which satisfies equation (15).

σ(k)=σ(k+1) (15)

By applying equations (12), (13), and (14) to equation (15), the equivalent control input UEQ is calculated by equation (16).

$$UEQ ( k ) = ( 1 / b 11 ) \{ \begin{matrix}\begin{matrix}\begin{matrix}( 1 - a 11 - VPOLE ) CSA ( k ) + \\ \begin{matrix}( VPOLE - a 12 ) CSA ( k - 1 ) - \\ b 12 \times USL ( k - 1 ) +\end{matrix}\end{matrix} \\ \begin{matrix}CSACMD ( k + 1 ) + \\ ( VPOLE - 1 ) CSACMD ( k ) -\end{matrix}\end{matrix} \\ VPOLE \times CSACMD ( k - 1 )\end{matrix} \} \qquad ( 16 )$$

The reaching law control input URCH is calculated by equation (17).

URCH(k)=(−F/b11)σ(k) (17)

where “F” is a reaching law control gain.

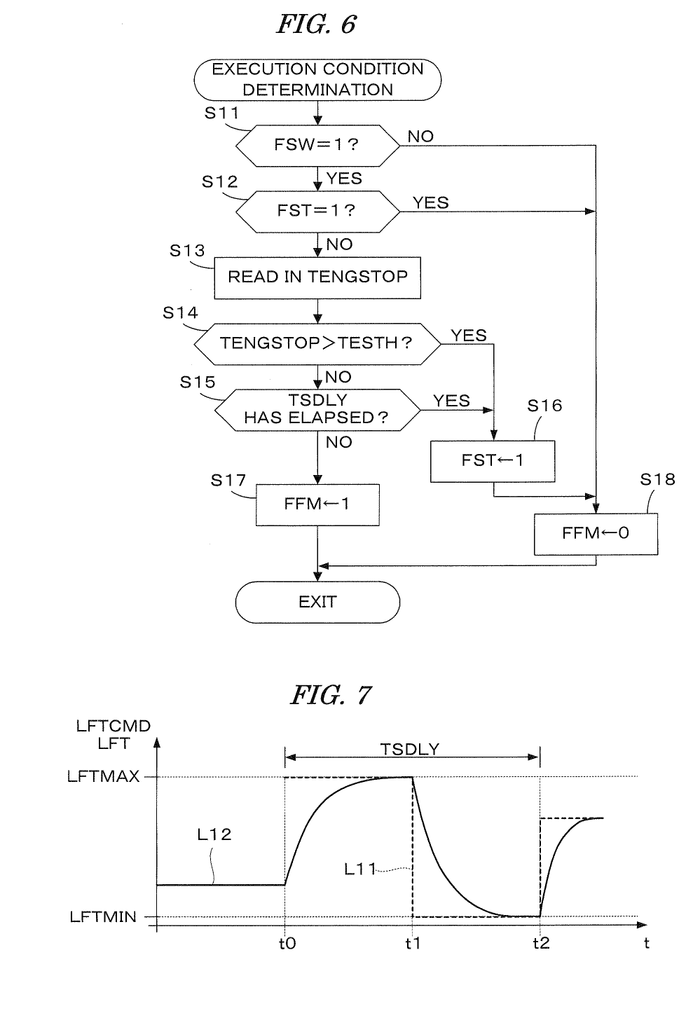

FIG. 6 is a flowchart of a process for setting the failure determination flag FFM in the execution condition determination block 105 of FIG. 5. This process is executed at predetermined time intervals by the CPU in the ECU 5.

In step S11, it is determined whether a start switch flag FSW is equal to “1”. The start switch flag FSW is set to “1” when the start switch 34 is turned on. If FSW is equal to “0”, the failure determination flag FFM is set to “0” (step S18).

If the start switch 34 is turned on, the process proceeds from step S11 to step S12, in which it is determined whether the start instruction flag FST is “1”. The start instruction flag FST is initially set to “0”, and is set to “1” in step S16. Therefore, the answer to step S12 is negative (NO) at first, and an engine stop period TENGSTOP is read in step S13. The engine stop period TENGSTOP is an elapsed time period from the end of the preceding operation of the engine 1 to the time the start switch 34 is turned on. The engine stop period TENGSTOP is measured by the timer in the ECU 5.

In step S14, it is determined whether the engine stop period TENGSTOP exceeds a predetermined stop period TESTH (e.g., 168 hours). If the answer to step S14 is negative (NO), it is determined whether a predetermined delay time period TSDLY (e.g., 1.2 seconds) has elapsed from the time the start switch 34 is turned on (step S15). Since the answer to step S15 is initially negative (NO), the process proceeds to step S17 in which the failure determination flag FFM is set to “1”.

Thereafter, when the answer to step S15 become affirmative (YES), the process proceeds to step S16 in which the start instruction flag FST is set to “1” and the failure determination flag FFM is returned to “0” (step S18). When the start instruction flag FST is set to “1”, the start of the engine 1 (actuation of the starting motor) is begun by a process which is not shown. Therefore, the failure determination flag FFM is set to “1” during the predetermined delay time period TSDLY which starts from the time the start switch 34 is turned on.

Further, if the engine stop period TENGSTOP exceeds the predetermined stop period TESTH, the process proceeds from step S14 to step S16 in which the start of the engine 1 is started without performing the failure determination.

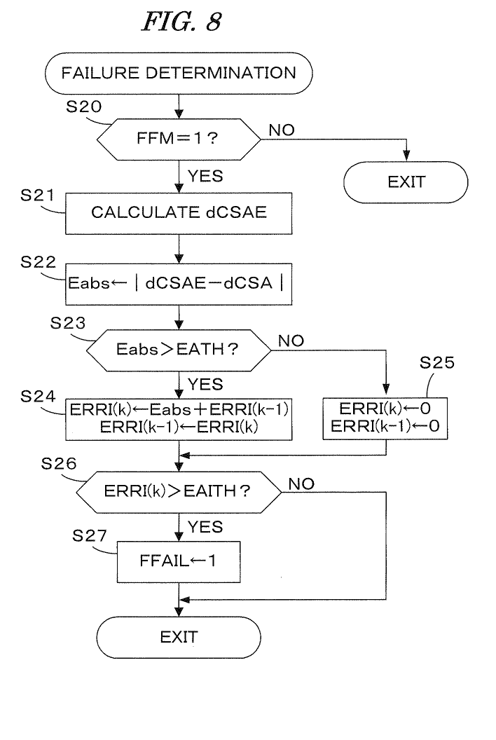

Next, the failure determination by the failure determination block 106 will be described with reference to FIGS. 7 and 8. FIG. 7 is a time chart showing changes in the lift amount command value LFTCMD of the intake valve and the actual lift amount LFT when performing the failure determination. The dashed line L11 corresponds to the lift amount command value LFTCMD and the solid line L12 corresponds to the actual lift amount LFT.

When the start switch 34 is turned on at time t0, the lift amount command value LFTCMD is first set to the maximum lift amount LFTMAX. Accordingly, the actual lift amount LFT increases to reach the maximum lift amount LFTMAX. Subsequently, after the lift amount LFT reaches the maximum lift amount LFTMAX, the lift amount command value LFTCMD is set to the minimum lift amount LFTMIN at time t1. Accordingly, the lift amount LFT decreases to reach the minimum lift amount LFTMIN. The failure determination is completed at time t2 when the predetermined delay time period TSDLY has elapsed from time t0, and the start of the engine 1 is initiated.

In the above-described embodiment, the first valve operating characteristic varying mechanism 41 is operated so that the lift amount LFT of the intake valve changes over the full movable range from the maximum lift amount LFTMAX to the minimum lift amount LFTMIN, and the failure determination process shown in FIG. 8 is performed. Therefore, a stuck failure and/or an abnormal friction increase in the first valve operating characteristic varying mechanism 41 is detected in the full movable range of the intake valve.

It is to be noted that FIG. 7 shows an example in which the lift amount command value LFTCMD is first set to the maximum lift amount LFTMAX and is subsequently set to the minimum lift amount LFTMIN. Alternatively, the lift amount command value LFTCMD may be primarily set to the minimum lift amount LFTMIN and subsequently set to the maximum lift amount LFTMAX. Further, within the predetermined delay time period TSDLY, the lift amount command value LFTCMD may first be set to the maximum value and next to the minimum value (or first to the minimum value and next to the maximum value), and again set to the maximum value (minimum value). In this case, the failure determination may be performed until the actual lift amount LFT secondly reaches the maximum lift amount LFTMAX (the minimum lift amount LFTMIN).

FIG. 8 is a flowchart of the failure determination process in the failure determination block 106. This process is executed at predetermined time intervals by the CPU in the ECU 5.

In step S20, it is determined whether the failure determination flag FFM is equal to “1”. If the answer to step S20 is negative (NO), the process immediately ends. When the failure determination flag FFM is equal to “1”, an estimated CS angular speed dCSAE is calculated by equation (21).

dCSAE(k)=C×(dCSACMD(k)−dCSAE(k−1))+dCSAE(k−1) (21)

Equation (21) is obtained from equation (5), which provides the transfer function F(s) of the extended controlled object 110. If the transfer function F(s) is expressed by equation (22), a transfer function Fa(s) is provided by equation (23).

F(s)=Fa(s)×(1/s) (22)

Fa(s)=1/(τs+1) (23)

Since (1/s) in equation (22) corresponds to the integrating operation, the transfer function Fa(s) corresponds to the transfer function from the target CS angular speed dCSACMD to the CS angular speed dCSA. Therefore, the estimated CS angular speed dCSAE is calculated by equation (24) in the continuous time system.

dCSAE=Fa(s)×dCSACMD (24)

Equation (21) is obtained by converting equation (24) to an equation of the discrete time system. The constant C in equation (21) is provided by equation (25) using the control period T and the time constant τ.

C=T/(τ+T) (25)

Referring back to FIG. 8, in step S22, a speed deviation Eabs is calculated by equation (26).

Eabs=|dCSAE−dCSA| (26)

In step S23, it is determined whether the speed deviation Eabs is greater than a first threshold value EATH. If the answer to step S23 is negative (NO), i.e., the speed deviation Eabs is negligibly small, both of a deviation integrated value ERRI (k) and a preceding value ERRI(k−1) thereof are set to “0” (step S25).

If Eabs is greater than EATH in step S23, the deviation integrated value ERRI(k) is calculated by equation (27), and the preceding value ERRI(k−1) is set to the present value ERRI(k) (step S24).

ERRI(k)=Eabs+ERRI(k−1) (27)

In step S26, it is determined whether the deviation integrated value ERRI(k) is greater than a second threshold value EAITH. If the answer to step S26 is negative (NO), the process immediately ends. On the other hand, if the deviation integrated value ERRI(k) is greater than the second threshold value EAITH, it is determined that the controlled object 100 (the first valve operating characteristic varying mechanism 41, the motor 43, or the motor drive circuit) has failed, and a failure detection flag FFAIL is set to “1” (step S27).

According to the process of FIG. 8, the failure determination is performed based on the speed deviation Eabs, which is a difference between the estimated CS angular speed dCSAE and the actual CS angular speed dCSA. Generally, the failure determination is performed based on the angular deviation, which is a difference between the CS angle CSA (which is a controlled output) and the estimated CS angle CSAE. However, the ratio of the time period in which the angular deviation takes a comparatively large value tends to be great even if the controlled object is normal. Therefore, there remains room for improvement in accuracy of the determination. Since the speed deviation Eabs shows good converging performance when the controlled object is normal, a deterioration of the control response due to the failure of the controlled object is determined with sufficient accuracy. Consequently, accuracy of the failure determination is improved by using the speed deviation Eabs.

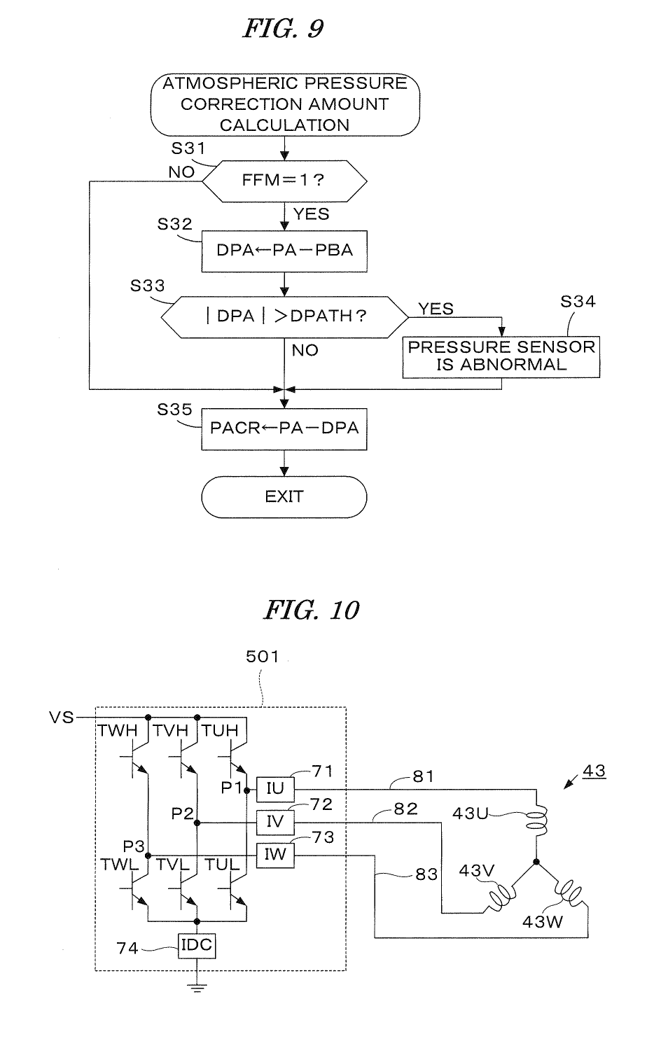

FIG. 9 is a flowchart of the atmospheric pressure correction amount calculation process executed at predetermined time intervals by the CPU in the ECU 5.

In step S31, it is determined whether the failure determination flag FFM is equal to “1” like step S20 of FIG. 8. If the answer to step S31 is negative (NO), the process immediately proceeds to step S35.

If the failure determination flag FFM is equal to “1”, the atmospheric pressure PA detected by the atmospheric pressure sensor 33 and the intake pressure PBA detected by the intake pressure sensor 8 are applied to equation (31) to calculate an atmospheric pressure correction amount DPA (step S32). Since a sensor of higher precision than that of the atmospheric pressure sensor 33 is used for the intake pressure sensor 8, the atmospheric pressure correction amount DPA is calculated on the basis of the detected value of the intake pressure sensor.

DPA=PA−PBA (31)

In step S33, it is determined whether an absolute value of the atmospheric pressure correction amount DPA is greater than a determination threshold value DPATH. Since the answer to step S33 is normally negative (NO), the process proceeds to step S35 in which the detected atmospheric pressure PA and the atmospheric pressure correction amount DPA are applied to equation (32) to calculate a corrected atmospheric pressure PACR.

PACR=PA−DPA (32)

If the absolute value of the atmospheric pressure correction amount DPA is greater than the determination threshold value DPATH in step S33, it is determined that the atmospheric pressure sensor 33 and/or the intake pressure sensor 8 are/is abnormal.

The corrected atmospheric pressure PACR calculated by the process of FIG. 9 is applied to the engine control in other processes which are not shown.

According to the process of FIG. 9, the atmospheric pressure correction amount DPA is calculated during the predetermined delay time period TSDLY from the time the start switch 34 is turned on to the moment the engine is actually started. If the time period from calculation of the atmospheric pressure correction amount DPA to the actual use of DPA becomes relatively long, there is a possibility that accuracy of the atmospheric pressure correction amount DPA may be reduced due to changes in environmental conditions. Therefore, by calculating the atmospheric pressure correction amount DPA during the predetermined delay time period TSDLY, accuracy of the atmospheric pressure correction amount DPA is improved.

Further, when the absolute value of the atmospheric pressure correction amount DPA is greater than the determination threshold value DPATH, the intake pressure sensor 8 and/or the atmospheric pressure sensor 33 are/is determined to be abnormal. Therefore, abnormality of the intake pressure sensor and/or the atmospheric pressure sensor can quickly be detected.

Next, the failure determination of the motor 43 for actuating the first valve operating characteristic varying mechanism 41 and a drive circuit of the motor 43 will be described below. A brushless DC motor or a brush DC motor may be used as the motor 43. Therefore, the failure determination method corresponding to each motor will be described below.

### Example of Using Brushless DC Motor

FIG. 10 is a circuit diagram of an equivalent circuit of the motor 43 and the motor drive circuit 501. The motor drive circuit 501 is provided in the output circuit of the ECU 5. The motor 43 has coils 43U, 43V, and 43W which are, respectively, connected to output points P1, P2, and P3 of the motor drive circuit 501 through connection wires 81, 82, and 83. Current sensors 71 to 73 are, respectively, provided for the connection wires 81, 82, and 83, and electric currents IU, IV, and IW flowing through the connection wires 81, 82, and 83 are, respectively, detected by the current sensors 71 to 73.

The motor drive circuit 501 includes transistors TUH, TUL, TVH, TVL, TWH, and TWL, and the drive signal of the motor 43 is supplied to the bases of the transistors. Each collector of the transistors TUH, TVH, and TWH is connected to the power supply VS, and each emitter of transistors TUL, TVL, and TWL is connected to the ground through a current sensor 74. The current sensor 74 detects a whole current IDC.

The connecting point of the transistor TUH emitter and the transistor TUL collector is an output point P1, the connecting point of the transistor TVH emitter and the transistor TVL collector is an output point P2, and the connecting point of the transistor TWH emitter and the transistor TWL collector is an output point P3.

The detection signal of each current sensor 71 to 74 is supplied to the CPU in the ECU 5 through the input circuit.

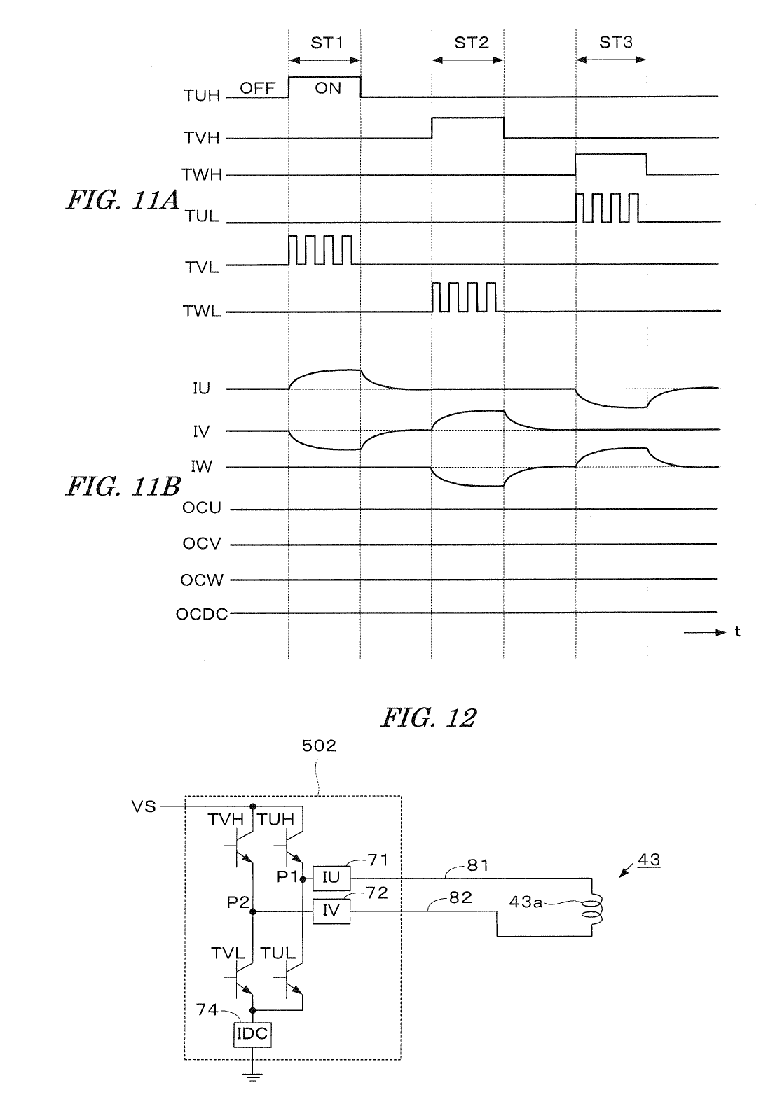

The CPU in the ECU 5 supplies predetermined drive signals for failure determination to the motor drive circuit 501, and performs the failure determination according to the detected present currents IU, IV, IW, and IDC. Specifically, the drive signals for the failure determination shown in FIG. 11A are supplied to the transistors. It is determined that a current flows through the corresponding transistor (status level “1”) if each of the absolute values of the detected currents IU, IV, IW, and IDC in stages ST1 to ST3 exceeds a predetermined lower limit value ILL (set to a value slightly greater than “0”); and it is determined that no current flows through the corresponding transistor (status level “0”) if each of the absolute values of the detected currents IU, IV, IW, and IDC in stages ST1 to ST3 is less than the predetermined lower limit value ILL. Further, it is determined that an excessive current flows through the corresponding transistor (status level “1”) if each of the absolute values of detected currents IU, IV, IW, and IDC exceeds a predetermined upper limit value ILH, and it is determined that the excessive current does not flow through the corresponding transistor (status level “0”) if each of the absolute values of detected currents IU, IV, IW, and IDC is less than the predetermined upper limit value ILH. Excessive-current status parameters OCU, OCV, OCW, and OCDC are set to “0” or “1” according to the determination results. The excessive-current status parameters OCU, OCV, OCW, and OCDC, respectively, correspond to the detected currents IU, IV, IW, and IDC.

FIG. 11B shows the detected currents IU, IV, and IW and the excessive-current status parameters OCU, OCV, OCW, and OCDC when the motor 43 and the motor drive circuit 501 are both normal. With respect to the detected currents IU, IV, and IW, the status level “1” indicates that the current is normal. With respect to the excessive-current status parameters OCU, OCV, and OCW and OCDC, the status level “0” indicates that the current is normal. The detected results are obtained as a 7-bit status code (for example, a status code corresponding to the stage ST1 of FIG. 11B is expressed as “1100000”). Further, by combining the status codes of three stages, one failure determination process result is obtained.

It is to be noted that when calculating a sum of three-phase currents (this sum will be referred to as “sum current”) IUVW (=IU+IV+IW) taking the direction (sign) of the detected current into account, the sum current IUVW is equal to “0” in the normal statue, and the sum current IUVW takes a value other than “0” if any abnormality has occurred. Therefore, one bit indicative of the status level obtained from the sum current IUVW may be added to the above-described 7-bit status code to make the status code consist of 8 bits. In this case, the added bit may be set to a status level “0” when the sum current IUVW is equal to “0”, and set to a status level “1” when the sum current IUVW takes a value other than “0”. The failure determination may be performed using the 8-bit status code (for example, status code corresponding to the stage ST1 of FIG. 11B is expressed as “11000000”).

The exclusive-OR (XOR) operation of the combined status code DC and a normal code NC corresponding to the normal status is performed to calculate an abnormality detection code EC. If the abnormality detection code EC is equal to “0”, it is determined that the motor 43 and the motor drive circuit 501 are both normal. On the other hand, if the abnormality detection code EC is not equal to “0”, it is further determined whether the abnormality detection code EC is equal to any one of a plurality of circuit failure codes FCC corresponding to the failure of the motor drive circuit 501 and a plurality of motor failure codes FMC corresponding to the failure of the motor 43. The circuit failure codes FCC and motor failure codes FMC are previously set. Further, according to the result obtained from the above determination, it is determined which of the motor drive circuit 501 or the motor 43 has failed. It is to be noted that, in this embodiment, disconnection and fault of the connection wires 81 to 83 are included in the failure of the motor 43.

### Example of Using Brush DC Motor

FIG. 12 is a circuit diagram showing a configuration of the equivalent circuit of the motor 43 and the motor drive circuit 502 in an example using a brush DC motor. The motor 43 has a coil 43a connected to output points P1 and P2 through the connection wires 81 and 82. The motor drive circuit 502 corresponds to a circuit obtained by deleting the transistors TWH and TWL in the motor drive circuit 501. The current sensors 71, 72, and 74 are provided like the motor drive circuit 501. Further, voltages VU and VV at the output points P1 and P2 are supplied to the CPU through the input circuit.

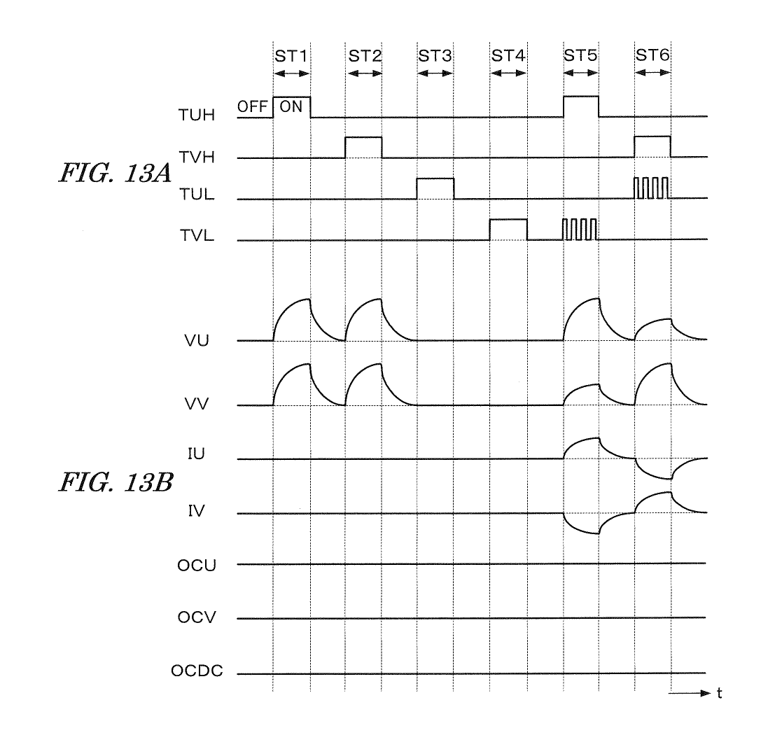

FIG. 13A shows drive signals for the failure determinations in this embodiment, and the drive signals are supplied to the transistors shown in the FIG. 13A. Further, FIG. 13B shows the detected voltages VU and W, the detected currents IU and IV, and the excessive-current parameters OCU, OCV, and OCDC in the normal status. It is determined that a voltage exists (status level “1”) when each of the detected voltages VU and VV exceeds a predetermined lower limit value VLL (which is set to a value slightly greater than “0”), and it is determined that no voltage exists (status level “0”) when each of the detected voltages VU and VV is less than the predetermined lower limit value VLL.

Also in this embodiment, the status codes corresponding to the stages ST1 to ST6 are obtained, and these status codes are combined to make the status code DC. In this embodiment, the sum current IUV (=IU+IV) is equal to “0” in the normal status and takes a value other than “0” in the abnormal status. Therefore, the status levels can be set according to the sum current IUV like the case of using the brushless DC motor, and the failure determination is performed based on the 8-bit status code.

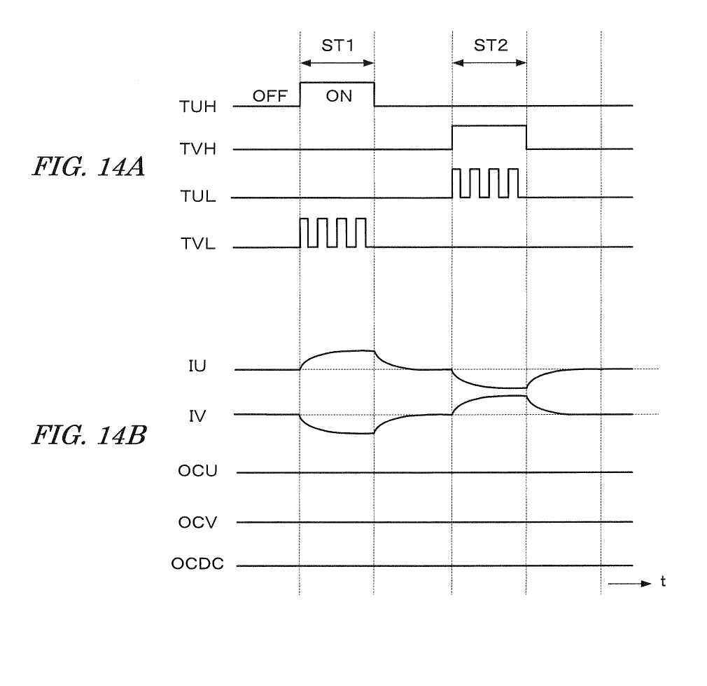

It is to be noted that, when using the brush DC motor, the failure determination wherein the detected voltages VU and VV are not used can be performed. FIG. 14A shows drive signals for such failure determination and FIG. 14B shows the detected currents IU and IV and the excessive-current parameters OCU, OCV, and OCDC in the normal status.

In the example shown in FIGS. 14A and 14B, the 5-bit status codes corresponding to the stages ST1 and ST2 are obtained. By combining these status codes, the status code DC is obtained. Also in this example, the status levels can be set according to the sum current IUV (=IU+IV), and the failure determination may be performed based on the 6-bit status code.

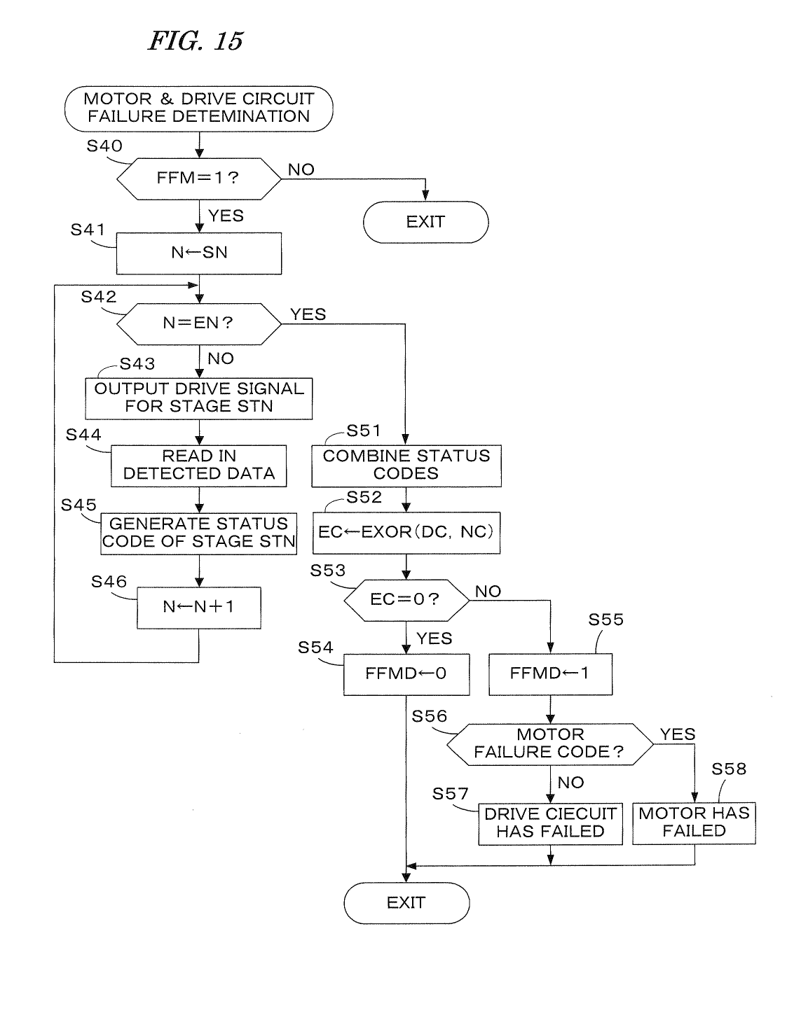

FIG. 15 is a flowchart showing a process for performing the above-described failure determination. It is preferable that this failure determination process is executed when the failure detection flag FFAIL is set to “1” in the above-described process of FIG. 8. Alternatively, this failure determination may always be performed before the beginning of the determination by the process of FIG. 8, or after the end of the determination by the process of FIG. 8.

In step S40, it is determined whether the failure determination flag FFM is equal to “1”. If the answer to step S40 is negative (NO), the process immediately ends. If the failure determination flag FFM is equal to “1”, the process proceeds to step S41 in which a stage number N is set to an initial value ST. The initial value ST is set to “1” in the examples of FIGS. 11A, 11B, 13A, 13B, 14A, and 14B. In step S42, it is determined whether the stage number N is equal to a final value EN. The final value EN is set to “3” in the example of FIGS. 11A and 11B; set to “6” in the example of FIGS. 13A and 13B; and set to “2” in the example of FIGS. 14A and 14B. Since the answer to step S42 is initially negative (NO), the drive signals for the failure determination corresponding to the stage STN are output (step S43), and the detected currents (detected voltages) and the excessive-current parameters are read in step S44.

In step S45, the detected values read in step S44 are converted to the status levels to make the status codes. Subsequently, the stage number N is incremented by “1” and the process returns to step S42. If the answer to step S42 becomes affirmative (YES), the process proceeds to step S51 in which the status codes corresponding to the plurality of stages are combined to make the status code DC.

Next, the XOR operation of the status code DC and the normal code NC is performed to calculate the abnormality detection code EC (step S52). Subsequently, it is determined whether the abnormality detection code EC is equal to “0” (step S53). If the answer to step S53 is affirmative (YES), a motor drive failure detection flag FFMD is set to “0” (step S54).

If the answer to step S53 is negative (NO), the motor drive failure detection flag FFMD is set to “1” (step S55), and it is determined whether the abnormality detection code EC coincides with any one of the plurality of motor failure codes (step S56). If the answer to step S56 is affirmative (YES), it is determined that the motor 43 has failed (step S58). On the other hand, if the answer to step S56 is negative (NO), it is determined that the motor drive circuit (501, 502) has failed.

As described above, in this embodiment, the failure determination of the controlled object 100, which includes the first valve operating characteristic varying mechanism 41, is performed during the time period from when the start switch 34 is operated to the moment the predetermined delay time period TSDLY has elapsed, and the start of the engine 1 is begun after the predetermined delay time period TSDLY has elapsed. The predetermined delay time period TSDLY, from operation of the start switch to the actual beginning of the engine start, can be set to a fixed time period within the limit wherein the driver does not sense a disturbance. Therefore, the time period required for the failure determination to occur is maintained with a high degree of certainty. Further, since the failure determination can always be performed immediately before starting the engine, the failure determination can be performed at a comparatively high frequency without affecting the normal operation of engine.

Further, the first valve operating characteristic varying mechanism 41 can smoothly operate using the lubricating oil supplied during operation of the engine. However, if the engine stop period TENGSTOP becomes relatively long and exceeds the predetermined stop period TESTH, the lubricating oil film adhered to movable parts during the engine operation is lost. Accordingly, if the valve operating characteristic varying mechanism 41 is operated in such a state before the engine starts, problems such as accelerated abrasion of movable parts or excessive load on the motor may occur. Therefore, by inhibiting the failure determination when the engine stoppage period has exceeded the predetermined time period (steps S13 and S14 of FIG. 6), the problems caused by the lack of lubricant film are avoided.

By the process of FIG. 15, failure determination of the motor 43 and the motor drive circuit 501 (502) is performed during the time period from the moment the start switch 34 is operated to when the predetermined delay time period TSDLY has elapsed. Therefore, a failure of the drive system can be detected distinct from other failures of the first valve operating characteristic varying mechanism 41. Further, a failure of the motor 43 and a failure of the motor drive circuit can be determined distinct from each other.

In this embodiment, the first valve operating characteristic varying mechanism 41, the motor 43, and the motor drive circuit correspond to a valve operating characteristic varying means, and the ECU 5 constitutes an engine starting means, a failure determination means, an inhibiting means, a correction amount calculating means, and an abnormality determining means. Specifically, the processes of FIGS. 8 and 15 correspond to the failure determination means, steps S13, S14, and S18 of FIG. 6 correspond to the inhibiting means, steps S31 and S32 of FIG. 9 correspond to the correction amount calculating means, and steps S33 and S34 correspond to the abnormality determining means.

The present invention is not limited to the embodiments described above, and various modifications may be made thereto. For example, in the above-described embodiments, the failure determination of the controlled object 100 is performed based on the speed deviation Eabs. The present invention is applicable regardless of the failure determination methods. For example, the present invention is applicable to the above-described determination method based on the angular deviation.

Further, in the above-described embodiments, the control system which uses the sliding mode controller 101 and the proportional-integral controller 103 is shown. The present invention is applicable to any control system which performs feedback control, regardless of the employed control method (for example, the proportional-integral-differential control, the proportional-differential control, the H∞ control, or the backstepping control).

The present invention can also be applied to a control system for a watercraft propulsion engine, such as an outboard engine having a vertically extending crankshaft.

The present invention may be embodied in other specific forms without departing from the spirit or essential characteristics thereof. The presently disclosed embodiments are therefore to be considered in all respects as illustrative and not restrictive, the scope of the invention being indicated by the appended claims, rather than the foregoing description, and all changes which come within the meaning and range of equivalency of the claims are, therefore, to be embraced therein.

What is claimed is:

1. A control system for an internal combustion engine having a valve operating characteristic varying means for continuously changing a lift amount of at least one intake valve, said control system comprising:
a start switch for instructing a start of said engine when said start switch is operated;
engine starting means for beginning the start of said engine after a predetermined delay time period has elapsed from the time the start switch is operated; and
failure determination means for operating said valve operating characteristic varying means during the predetermined delay time period, and performing a failure determination of said valve operating characteristic varying means.

2. The control system according to claim 1, further comprising inhibiting means for inhibiting the failure determination by said failure determination means after a predetermined time period has elapsed from an end of a preceding operation of said engine.

3. The control system according to claim 1, wherein said valve operating characteristic varying means has a motor for varying the lift amount of said at least one intake valve and a drive circuit for driving the motor, and wherein said failure determination means performs a failure determination of the motor during the predetermined delay time period.

4. The control system according to claim 3, wherein said failure determination means performs a failure determination of the drive circuit during the predetermined delay time period.

5. The control system according to claim 1, further comprising:
an intake pressure sensor for detecting an intake pressure of said engine;
an atmospheric pressure sensor for detecting an atmospheric pressure, and
correction amount calculating means for calculating a correction amount for correcting a detected value of the atmospheric pressure sensor according to a detected value of the intake pressure sensor during the predetermined delay time period.

6. The control system according to claim 5, further comprising abnormality determining means for determining that at least one of the intake pressure sensor and the atmospheric pressure sensor is abnormal when the correction amount calculated by said correction amount calculating means is greater than a predetermined threshold value.

7. A control method for an internal combustion engine having a valve operating characteristic varying device for continuously changing a lift amount of at least one intake valve, said control method comprising the steps of:
a) detecting operation of a start switch, which instructs a start of said engine;
b) beginning the start of said engine after a predetermined delay time period has elapsed from a moment operation of the start switch is detected; and
c) operating said valve operating characteristic varying device during the predetermined delay time period, and performing a failure determination of said valve operating characteristic varying device.

8. The control method according to claim 7, further comprising the step of d) inhibiting the failure determination by said step c) after a predetermined time period has elapsed from an end of a preceding operation of said engine.

9. The control method according to claim 7, wherein said valve operating characteristic varying device has a motor for varying the lift amount of said at least one intake valve and a drive circuit for driving the motor, and
said control method further comprises the step of e) performing a failure determination of the motor during the predetermined delay time period.

10. The control method according to claim 9, further comprising the step of f) performing a failure determination of the drive circuit during the predetermined delay time period.

11. The control method according to claim 7, further comprising the steps of
g) detecting an intake pressure of said engine with an intake pressure sensor;
h) detecting an atmospheric pressure with an atmospheric pressure sensor; and
i) calculating a correction amount for correcting a detected value of the atmospheric pressure sensor according to a detected value of the intake pressure sensor during the predetermined delay time period.

12. The control method according to claim 11, further comprising the step of j) determining that at least one of the intake pressure sensor and the atmospheric pressure sensor is abnormal when the correction amount calculated in said step i) is greater than a predetermined threshold value.

13. A computer program embodied on a computer-readable medium for causing a computer to implement a control method for an internal combustion engine having a valve operating characteristic varying device for continuously changing a lift amount of at least one intake valve, said control method comprising the steps of:
a) detecting operation of a start switch, which instructs the start of said engine;
b) beginning the start of said engine after a predetermined delay time period has elapsed from the time the operation of the start switch is detected; and
c) operating said valve operating characteristic varying device during the predetermined delay time period, and performing a failure determination of said valve operating characteristic varying device.

14. The computer program according to claim 13, wherein said control method further comprises the step of d) inhibiting the failure determination by said step c) after a predetermined time period has elapsed from an end of a preceding operation of said engine.

15. The computer program according to claim 13, wherein said valve operating characteristic varying device has a motor for varying the lift amount of said at least one intake valve and a drive circuit for driving the motor, and
said control method further comprises the step of e) performing a failure determination of the motor during the predetermined delay time period.

16. The computer program according to claim 15, wherein said control method further comprises the step of f) performing a failure determination of the drive circuit during the predetermined delay time period.

17. The computer program according to claim 13, wherein said control method further comprises the steps of
g) detecting an intake pressure of said engine with an intake pressure sensor;
h) detecting an atmospheric pressure with an atmospheric pressure sensor; and
i) calculating a correction amount for correcting a detected value of the atmospheric pressure sensor according to a detected value of the intake pressure sensor during the predetermined delay time period.

18. The computer program according to claim 17, wherein said control method further comprises the step of j) determining that at least one of the intake pressure sensor and the atmospheric pressure sensor is abnormal when the correction amount calculated in said step i) is greater than a predetermined threshold value.
